(19) United States
(12) Patent Application Publication
(10) Pub. No.: US 2024/0268392 A1
(43) Pub. Date: Aug. 15, 2024

(54) ANTIMICROBIAL PROTECTIVE LAYER, SUBSTRATE HAVING THE ANTIMICROBIAL PROTECTIVE LAYER, AND METHOD FOR PRODUCING THE SUBSTRATE HAVING THE ANTIMICROBIAL PROTECTIVE LAYER

(71) Applicant: Siemens Aktiengesellschaft, München (DE)

(72) Inventors: Gabriele Winkler, Berlin (DE); Jens Dahl Jensen, Berlin (DE); Ursus Krüger, Berlin (DE)

(21) Appl. No.: 18/569,402

(22) PCT Filed: Jun. 8, 2022
(86) PCT No.: PCT/EP2022/065530

§ 371 Date: Dec. 12, 2023

(30) Foreign Application Priority Data
Jun. 22, 2021 (EP) 21180740.9

(51) Int. Cl. A01N 59/16; A01N 25/06; A01N 25/08; A01P 1/00; C09D 1/00; C09D 5/14; C09D 7/61

(52) U.S. Cl. CPC A01N 59/16; A01N 25/06; A01N 25/08; A01P 1/00; C09D 1/00; C09D 5/14; C09D 7/61

(57) ABSTRACT

An antimicrobial protective layer for protecting a substrate surface of a substrate has at least one antimicrobial reagent having a reagent coloring and at least one inert inorganic color pigment having a color-pigment coloring different from the reagent coloring, and the reagent concentration of the reagent in the protective layer and the color-pigment concentration of the inorganic color pigment in the protective layer being selected in such a way that a protective-layer coloring of the protective layer differs from the reagent coloring. Further provided is a substrate having the protective layer for protecting a substrate surface of the substrate. The object is, for example, an object of a public way of transportation or an object of an infrastructure installation used by multiple persons. In addition, provided is a method for producing the substrate having the protective layer.

### CROSS-REFERENCE TO RELATED APPLICATIONS

This application claims priority to PCT Application No. PCT/EP2022/065530, having a filing date of Jun. 8, 2022, which claims priority to EP Application No. 21180740.9, having a filing date of Jun. 22, 2021, the entire contents both of which are hereby incorporated by reference.

### FIELD OF TECHNOLOGY

The following relates to an antimicrobial protective layer and a substrate comprising the antimicrobial protective layer. A method for producing the substrate comprising the antimicrobial protective layer is also presented.

### BACKGROUND

A substrate can be composed of any desired substrate material such as plastic, metal or ceramic. A substrate surface of the substrate is often provided with an antimicrobial protective layer in order to prevent adherence of bacteria, viruses or other microorganisms to the substrate surface. For this purpose, for example, the antimicrobial protective layer has a bactericidal, virucidal and/or fungicidal action.

A component of the antimicrobial protective layer is for example antibacterial manganese dioxide (MnO₂), which is produced by wet-chemical means from potassium permanganate (KMnO₄) and manganese(II) salts via a redox reaction and applied to the substrate surface (precipitation). A drawback of manganese dioxide is its brown to dark-brown color. The result is that the protective layer coloring of the protective layer is also brown to dark brown. The possibility of using such an antimicrobial protective layer is therefore highly limited.

### SUMMARY

An aspect relates to demonstrate how the composition of an antimicrobial protective layer can be configured so that it can be variably used for protecting a substrate surface of a substrate with respect to the coloring of the protective layer.

In order to achieve this aspect, an antimicrobial protective layer for protecting a substrate surface of a substrate is disclosed, wherein the protective layer comprises at least one antimicrobial reagent (antimicrobial agent) having a reagent coloring and at least one inert inorganic color pigment having a color pigment coloring different from the reagent coloring and wherein a reagent content of the reagent in the protective layer and a color pigment content of the inorganic color pigment in the protective layer are selected such that a protective layer coloring of the protective layer differs from the reagent coloring. According to a special embodiment, the protective layer has a selected protective layer thickness ranging from 0.5 μm to 20 μm and in particular ranging from 1 μm to 10 μm.

The protective layer coloring (color of the protective layer) is a mixture (mixed color) of the reagent coloring (color of the reagent) and the color pigment coloring (color of the color pigment). In this case, the antimicrobial action of the antimicrobial reagent and thus the antimicrobial action of the protective layer is retained. The protective layer has an antibacterial and/or antiviral action. The protective layer ensures that bacteria and/or viruses are killed, cannot adhere or can only adhere poorly to the substrate surface. At the same time, the coloring of the protective layer can be adjusted as desired.

The inorganic color pigment is inert. This means that it does not impair the antimicrobial effectiveness of the antimicrobial reagent. Likewise, in the production method, the inorganic color pigment does not impair application of the antimicrobial reagent or the antimicrobial protective layer to the substrate surface or a starting substrate surface of a starting substrate. The application capacity (applicability) of the protective layer to the substrate surface or starting substrate surface is retained.

In order to achieve the aspect, a substrate comprising the protective layer for protecting a substrate surface of the substrate is also disclosed. The substrate can be any object with a surface to be protected. The object is, for example, an object in a public means of transportation or an object of an infrastructure device used by multiple persons (e.g. a network printer, a desk in an open plan office, etc.).

According to a further aspect of embodiments of the invention, a method is provided for producing the substrate comprising the protective layer comprising the following method steps:

a) providing a starting substrate with a starting substrate surface, and
b) arranging the protective layer on the starting substrate surface.

In a particular embodiment, the protective layer comprise a further, color neutral antimicrobial reagent. The further antimicrobial reagent improves the antimicrobial action of the protective layer. As the further antimicrobial reagent is color neutral, it makes no or virtually no contribution to the color of the protective layer. The protective layer coloring is not substantially influenced by a coloring of the further, color neutral antimicrobial reagent. Elemental silver (Ag) is used in particular as a further, color neutral antimicrobial reagent.

The antimicrobial reagent comprises an antimicrobial metal oxide compound. An example of this is titanium dioxide (TiO₂). In particular, the antimicrobial metal oxide compound is manganese dioxide (pyrolusite, MnO₂).

The antimicrobial properties of manganese dioxide are highly interesting because with silver, which also acts as a antimicrobial reagent, manganese dioxide forms oxygen radicals from oxygen and moisture in the air (water) that are also known as ROS (reactive oxygen species). These highly reactive oxygen species can destroy proteins, lipids, RNA or DNA, of which bacteria are composed, in such a way that they undergo a chemical reaction therewith and thus make bacteria and viruses harmless.

The inert inorganic color pigment comprises at least one metal oxide compound and/or a metal hydroxide compound. In a particular embodiment, the inert inorganic color pigment can be assigned to at least one crystal structure type selected from the group of baddeleyite, garnet, inverse spinel, cassiterite, corundum, olivine, perovskite, phenakite, rutile, silicate, sphene (titanite), spinel, stannate and zircon (zirconate silicate).

Depending on the color of the inorganic color pigment, the brown color of the manganese dioxide is lightened, reddish-green, gray, ochre-brown or olive to lime green, so that a corresponding protective layer coloring is produced.

The following lists of various inorganic color pigments with their color pigment colorings are given only by way of example and are not exhaustive.

Inorganic color pigments with blue color pigment coloring:
Thenard's blue (cobalt blue): cobalt(II) aluminum oxide (CoAl₂O₄) with a crystalline spinel matrix.
Egyptian blue: copper(II) calcium silicate (CaCuSi₄O₁₀).
Chinese blue (Han blue): copper(II) barium silicate (BaCuSi₂O₆).
zircon vanadium blue (zircon Coelin blue): (Zr, V)SiO₄ with a crystalline zircon matrix.
cobalt zinc aluminate blue: (Co,Zn)Al₂O₄ with a crystalline spinel matrix.
cobalt silicate: Co₂SiO₄ with a crystalline olivine matrix.
cobalt zinc silicate blue: (Co,Zn)₂SiO₄ with a crystalline phenakite matrix.

Inorganic color pigments with green color pigment coloring:
Rinmann's green (cobalt green): cobalt(II) zincate, ZnCO₂O₄ (ZnO·Co₂O₃) with a crystalline spinel matrix.
chromium oxide green: Cr₂O₃.
Turkish green: Cr₂O₃—Al—CoO.
cobalt chromite green: CoCr₂O₄ with a crystalline spinel matrix.
cobalt titanate green: Co₂TiO₄ with a crystalline inverse spinel matrix.
Victoria green: 3CaO, Cr₂O₃, 3SiO₂ with a crystalline garnet matrix.

Inorganic color pigments with yellow color pigment coloring:
zircon silicate, ZrSiO₄.
chromium titanium yellow: (Ti,Ni,Sb,Cr)O₂.
zinc iron yellow (iron zinc oxide): ZnFe₂O₄.
nickel barium titanium pale yellow (primrose): 2NiO, 3BaO, 17TiO₂ with a crystalline priderite matrix.
tin vanadium yellow: (Sn, V)O₂ with a crystalline cassiterite matrix.
zircon praseodymium yellow: (Zr,Pr)SiO₄ with a crystalline zircon matrix.
zircon vanadium yellow: (Zr, V)O₂ with a crystalline baddeleyite matrix.
nickel niobium titanium yellow: (Ti,Ni,Nb)O₂ with a crystalline rutile matrix.
chromium niobium titanium yellowish-brown (buff): (Ti,Cr,Nb)O₂ with a crystalline rutile matrix.
chromium tungsten titanium yellowish-brown (buff) with a crystalline rutile matrix.

Inorganic color pigments with red color pigment coloring:
iron silicate: Fe₂O₃·SiO₂.
chromium stannate: Cr₂(SnO₃)₃.
zinc iron oxide: ZnFe₂O₄.
gold aluminum pink corundum: Al₂O₃+Au.
chromium aluminum pink corundum: (Al,Cr)₂O₃.
chromium aluminum pink corundum: (Al,Cr)₂O₃.
manganese aluminum pink corundum: (Al,Mn)₂O₃.
zircon iron pink zircon, (Zr, Fe)SiO₄.
chromium tin pink sphene: CaO, SnO₂, SiO₂, Cr₂O₃.
chromium aluminum pink spinel: Zn(Al,Cr)₂O₄.
chromium tin orchid cassiterite: (Sn,Cr)O₃.
English red: annealed iron(III) oxide, Fe₂O₃.
calcium aluminum silicate (garnet): Ca₃Al₂[SiO₄]₃.

Inorganic color pigments with white color pigment coloring:
titanium(IV) oxide (titanium dioxide): TiO₂ in the rutile structure.
barium titanate: BaTiO₄ in the perovskite structure.

The substrate comprising the substrate surface to be protected can be composed of any substrate materials. The substrate comprises at least one substrate material selected from the group of biological material, ceramic, plastic, and metal. The biological material is for example wood (from cellulose). Combinations of the above-mentioned substrate materials are also conceivable.

In a particular embodiment, the substrate material comprises a fiber material. The substrate material is at least partly fibrous. For example, the substrate material is a nonwoven material that is composed of synthetic fibers (e.g. with polypropylene or with polyamide) or also of cellulose-based materials.

In particular, with respect to the method, in order to arrange the protective layer, in particular, a spray method is carried out using at least one spray nozzle for spray application of at least one component of the protective layer and/or spray application of at least one starting substance of at least one component of the protective layer. A chemical spray method is used as a spray method. In the chemical spray method, at least one chemical reaction is initiated by spray application of the components. A chemical reaction occurs during and/or after the spray application (e.g. due to the effect of thermal energy during or after spray application). For example, the protective layer and/or at least one component of the protective layer is/are precipitated on the starting substrate surface by the chemical spray method. The protective layer or the component of the protective layer are applied by the chemical spray method as a precipitate.

The component and/or the starting substance of the component (according to the spray method) are selected from the group of an antimicrobial reagent, starting substance of the antimicrobial reagent, further antimicrobial reagent, starting substance of the further antimicrobial reagent, inorganic color pigment and starting substance of the inorganic color pigments.

In order to improve the method, the substrate, the substrate surface, the starting substrate, the starting substrate surface or the starting protective layer is heated before, during or after arranging the protective layer.

In particular, thermal energy is therefore introduced using a heat source in order to arrange the protective layer. The heat source can be any desired heat source, such as a source of infrared radiation.

According to a special embodiment, a roll-to-roll apparatus is used for the method for coating a flexible substrate. The method is configured as a roll-to-roll method (R2R). For this purpose, uncoated substrate located on a transport roller is unrolled, processed, and finally rolled up onto a further transport roller as a finished substrate provided with the protective layer. In this manner, the substrate can be produced in an automated and inexpensive manner.

In summary, embodiments of the invention has the following advantages.
The use of color pigments allows the antimicrobial brown manganese dioxide (silver) system of the protective layer to be used on visible surfaces such as oral and nasal protective masks.
Control elements of medical devices (such as computed tomography equipment, for example, magnetic resonance imaging devices or x-ray equipment) or the surfaces thereof can be attractively configured to be germ-free with the manganese dioxide (silver) system and the inorganic color pigments.
Contact surfaces in buildings and transport means (for example trains, aircraft and buses) heavily used by the public can be protected from germs with colored protective layers.
When silver and manganese dioxide are applied by a chemical spray method, this gives rise to brown to dark-brown spots. These spots can be alleviated by adding inorganic color or covered using a mixed color. The respective reactive spray media are added to the color pigments. In the case of the inorganic color pigments, chemically and energetically highly stable oxides and silicates that are insoluble in water, acids, and basic solutions are desired. As these color pigments are highly inert chemically, they do not participate in the chemical reactions of the reactive spray methods. They only provide an optically attractive surface. A further technical advantage of these color pigments is that because of their chemical structure (free electron pairs in the oxygen component of the oxide), they provide improved adhesion of the silver/manganese dioxide system to the surfaces.
In public transport means such as trains, the contact surfaces that are touched by the passengers can be protected by antimicrobial layers. This also applies in particular to the sanitary area of public transport means.
The same applies to the infrastructure of buildings (sanitary facilities, elevators, staircases, seats, desks, doorknobs, etc.) widely used by the public.
Control elements of medical devices (computed tomography equipment, magnetic resonance imaging devices, x-ray equipment) or the surfaces thereof with which patients can come into contact can be rendered germ-free with the antimicrobial protective layer.

### BRIEF DESCRIPTION

Some of the embodiments will be described in detail, with reference to the following figures, wherein like designations denote like members, wherein:

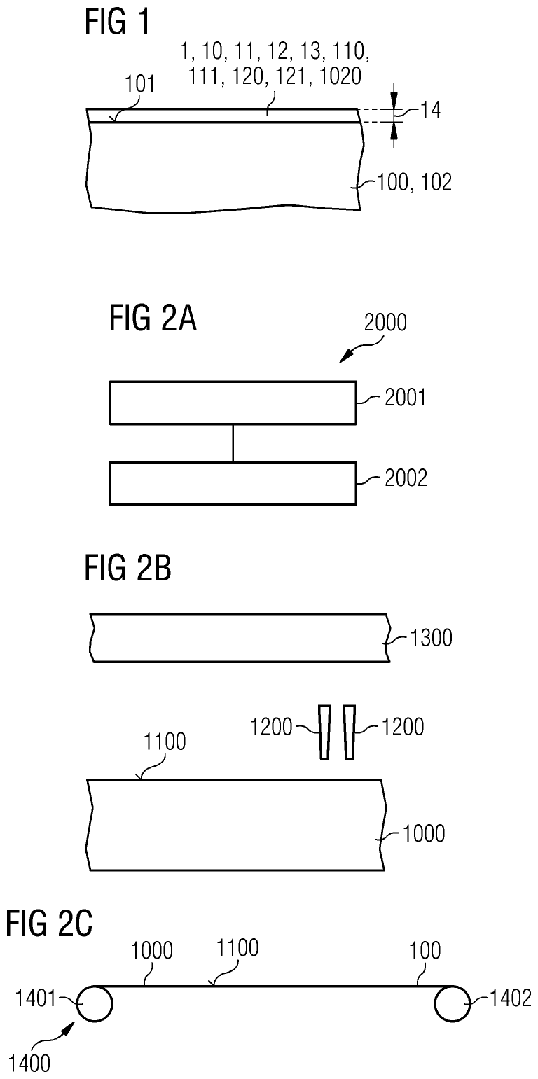

FIG. 1 shows a detail of a substrate comprising an antimicrobial protective layer in cross-section;

FIG. 2A shows a method for producing the substrate comprising the antimicrobial protective layer;

FIG. 2B shows a detail of a starting substrate in use of the method for producing the substrate with antimicrobial protective layer; and

FIG. 2C shows a roll-to-roll apparatus that can be used with the method.

### DETAILED DESCRIPTION

The exemplary embodiment pertains to an antimicrobial protective layer 1 for protecting a substrate surface 110 of a substrate 100, wherein the protective layer 1 comprises
at least one antimicrobial reagent 11 having a reagent coloring 110 and
at least one inert inorganic color pigment 12 with a color pigment coloring 120 different from the reagent coloring 110 and wherein
a reagent content 111 of the reagent 11 in the protective layer 1 and a color pigment content 121 of the inorganic color pigments 12 in the protective layer 1 are selected such that a protective layer coloring 10 of the protective layer 1 is different from the reagent coloring 110.

The antimicrobial reagent is MnO₂. The content of MnO₂ in the protective layer is about 30 to 50 wt. % based on the pure AgMnO₂ layer. In addition to MnO₂, elemental silver is present in the protective layer as a further, color neutral antimicrobial reagent 13. The content of elemental silver is about 25 to 50 wt. % based on the pure AgMnO₂ layer.

The inert inorganic color pigment is one of the above-mentioned color pigments with blue, red, yellow, green or white color pigment coloring.

The substrate 100 comprises fibrous substrate material 102 with cellulose. The substrate is composed of a flexible nonwoven material. The coated substrate surface is made up of cellulose fibers.

The protective layer thickness 14 of the antimicrobial protective layer is approx. 5 μm. In an alternative embodiment, the protective layer thickness is 10 μm.

In order to produce the substrate 100, the following method steps are carried out:

a) providing 2002 a starting substrate 1000 (with the cellulose fibers) with a starting substrate surface 1100 and
b) arranging 2002 the protective layer 1 on the starting substrate surface 1100.

A spray method is carried out for arranging 2002 the protective layer 1. For this purpose, at least one spray nozzle 1200 for spray application of at least one component of the protective layer and/or for spray application of at least one starting substance of at least one component of the protective layer is used. The spray method is configured as a chemical spray method. For this purpose, after the spray application, thermal energy is introduced using a heat source 1300 into the protective layer or the substrate.

As the substrate is flexible, a roll-to-roll apparatus 1400 can be used here. A roll-to-roll method is used. For this purpose, the uncoated substrate 1000 located on a transport roller 1401 is unrolled, processed, and rolled up again onto a further transport roller 1402 as a finished substrate 100 coated with the protective layer.

In the roll-to-roll method, the antimicrobial reagents are applied via the chemical spray method to the substrate surface by means of special nozzle technology.

In the chemical spray method, the manganese dioxide used is produced from a potassium permanganate solution and a solution of manganese(II) nitrate or manganese(II) acetate. Before the reaction of the two solutions, the manganese(II) nitrate or the manganese(II) acetate solution is adjusted to a pH of 8 (basic). This is done either by adding ammonia or ammonium chloride or by adding a basic amino acid such as L-lysine. Alternatively, other basic amino acids such as L-histidine or L-arginine are used.

The potassium permanganate solution and the basic manganese(II) salt solution are separately and simultaneously sprayed via two nozzles onto the substrate surface to be coated. At the moment the two solutions come into contact with each other, the manganese dioxide is formed and deposited as a precipitate on the substrate surface.

By means of comproportionating (special case of a redox reaction), manganese dioxide forms from Mn⁺⁷ and Mn⁺². In the reaction, the manganese(II) salt of potassium permanganate is oxidized to manganese(IV) oxide and the potassium permanganate is reduced from manganese(II) salt to manganese(IV) oxide. The manganese(IV) oxide is derived both from the reducing agent and the oxidizing agent. The reducing agent and the oxidizing agent thus serve as starting substances of manganese dioxide.

In order to accelerate the chemical reaction, the starting substrate surface with the applied starting protective is heated using a suitable heat source 1300.

In order to alleviate the brown color of the manganese dioxide, inorganic color pigments are suspended in the two solutions, i.e. both in the potassium permanganate solution and in the manganese(II) salt solution. The color pigments can have the same or a different chemical composition. These color pigments are then sprayed with the two reactants onto the substrate surface to be coated. In this case, the color pigments behave in chemically inert fashion and do not take part in the chemical reaction.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An antimicrobial protective layer for protecting a substrate surface of a substrate, wherein the protective layer
comprises at least one antimicrobial reagent having a reagent coloring and
at least one inert inorganic color pigment having a color pigment coloring different from the reagent coloring and wherein
a reagent content of the reagent in the protective layer and a color pigment content of the inorganic color pigment in the protective layer are selected such that a protective layer coloring of the protective layer differs from the reagent coloring.

2. The protective layer as claimed in claim 1, wherein the protective layer has a protective layer thickness selected from the range of 0.5 μm to 20 μm or from the range of 1 μm to 10 μm.

3. The protective layer as claimed in claim 1, wherein the protective layer comprises a further, color neutral antimicrobial reagent.

4. The protective layer as claimed in claim 3, wherein the further, color neutral antimicrobial reagent comprises elemental silver.

5. The protective layer as claimed in claim 1, wherein the antimicrobial reagent comprises an antimicrobial metal oxide compound.

6. The protective layer as claimed in claim 5, wherein the antimicrobial metal oxide compound is MnO₂.

7. The protective layer as claimed in claim 1, wherein the inert inorganic color pigment is assigned to at least one crystal structure type selected from the group baddeleyite, garnet, inverse spinel, cassiterite, corundum, olivine, perovskite, phenakite, rutile, sphene, silicate, spinel, stannate and zircon.

8. A substrate having the protective layer as claimed in claim 1 for protecting a substrate surface of a substrate.

9. The substrate as claimed in claim 8, wherein the substrate comprises at least one substrate material selected from the group of biological material, ceramic, plastic, and metal.

10. The substrate as claimed in claim 9, wherein the substrate material comprises a fiber material.

11. A method for producing the substrate as claimed in claim 8 by the following method steps:
a) arranging a starting substrate with a starting substrate surface and
b) arranging the protective layer on the starting substrate surface.

12. The method as claimed in claim 11, wherein for arranging the protective layer, a spray method using at least one spray nozzle for spray application of at least one component of the protective layer and/or for spray application of at least one starting substance of at least one component of the protective layer is carried out.

13. The method as claimed in claim 12, wherein a chemical spray method is used as a spray method.

14. The method as claimed in claim 12, wherein the component and/or the starting substance of the component is selected from the group of an antimicrobial reagent, starting substance of the antimicrobial reagent, further antimicrobial reagent, starting substance of the further antimicrobial reagent, inorganic color pigment and starting substance of the inorganic color pigments

15. The method as claimed in claim 11, wherein for arranging the protective layer, thermal energy is introduced using a heat source.

16. The method as claimed in claim 11, wherein for arranging, a roll-to-roll apparatus is used.
